(19) United States
(12) Patent Application Publication
(10) Pub. No.: US 2013/0138394 A1
(43) Pub. Date: May 30, 2013

(54) STATE DETECTING DEVICE, ELECTRONIC APPARATUS, AND PROGRAM

(71) Applicant: SEIKO EPSON CORPORATION, Tokyo (JP)

(72) Inventor: Koki SHIGA, Matsumoto-shi (JP)

(73) Assignee: SEIKO EPSON CORPORATION, Tokyo (JP)

(21) Appl. No.: 13/684,383

(22) Filed: Nov. 23, 2012

(30) Foreign Application Priority Data
Nov. 29, 2011 (JP) 2011-260507
Nov. 30, 2011 (JP) 2011-261497

(51) Int. Cl. G01C 22/00

(52) U.S. Cl. CPC G01C 22/006
USPC 702/160

(57) ABSTRACT

A state detecting device includes: an acquiring unit that acquires an acceleration detection value from an acceleration sensor; an average acceleration calculating unit that calculates an average acceleration in each predetermined period based on the acceleration detection value; a reference information acquiring unit that acquires a reference average acceleration and a reference step length; and a step length estimating unit that estimates a step length based on a ratio of the average acceleration to the reference average acceleration as well as the reference step length.

The present application claims a priority based on Japanese Patent Application No. 2011-261497 filed on Nov. 30, 2011 and Japanese Patent Application No. 2011-260507 filed on Nov. 29, 2011, the contents of which are incorporated herein by reference.

### BACKGROUND

1. Technical Field

The invention relates to a state detecting device, an electronic apparatus, and a program.

2. Related Art

A device in which an acceleration sensor is attached to an object whose the state is to be detected, and the state of the object is detected based on an acceleration value from the attached acceleration sensor, or the like, is known. For example, when a state detection object is a person, an acceleration sensor is attached to the body of the user to detect the state of the user (for example, an exercise state whether the user is running or walking). As a typical example, a pedometer that detects walking or running of a user to count the number of steps of the walking can be considered. Moreover, a device that calculates a step length of the user to measure a moving distance is also known.

In the related art, a distance measurement method of estimating a distance by taking the product of the number of steps (corresponding to detection of each step) of walking or running and a step length has been proposed. However, such a method allows easy processing, whereas poor step length calculation accuracy results in poor accuracy of distance measurement.

JP-A-7-333000 discloses a method of improving distance estimation accuracy by calculating a step length based on the pace of the user.

In the method disclosed in JP-A-7-333000, although the step length is calculated based on the pace, the relationship between the pace and the step length is not linear, and an individual difference of respective users is large. Thus, it is difficult to obtain sufficient accuracy in calculation of the step length. As a result, the distance estimation accuracy is also insufficient.

### SUMMARY

An advantage of some aspects of the invention is to provide a state detecting device, an electronic apparatus, and a program capable of increasing step length estimation accuracy by performing processing based on an average acceleration, a reference average acceleration, and a reference step length.

An aspect of the invention is directed to a state detecting device including: an acquiring unit that acquires an acceleration detection value from an acceleration sensor; an average acceleration calculating unit that calculates an average acceleration in each predetermined period based on the acceleration detection value; a reference information acquiring unit that acquires a reference average acceleration and a reference step length; and a step length estimating unit that estimates a step length based on a ratio of the average acceleration to the reference average acceleration as well as the reference step length.

According to the aspect of the invention, the average acceleration is acquired based on the acceleration detection value from the acceleration sensor, and the reference average acceleration as well as the reference step length are acquired. Moreover, the step length is estimated based on the ratio of the average acceleration to the reference average acceleration as well as the reference step length. By performing processing based on the average acceleration, it is possible to improve step length estimation accuracy.

In the aspect of the invention, the state detecting device may include a step detecting unit, and the reference information acquiring unit may acquire the reference step length based on input distance information and the number of steps detected by the step detecting unit in a reference information acquisition period.

In this way, it is possible to acquire the reference step length based on the input distance information and the number of steps.

In the aspect of the invention, the reference information acquiring unit may acquire the reference average acceleration based on the average acceleration acquired in the reference information acquisition period and the number of steps.

In this way, it is possible to acquire the reference average acceleration based on the average acceleration and the number of steps.

In the aspect of the invention, when the reference average acceleration is NA, the reference step length is NS, a coefficient is C, and the average acceleration acquired in a predetermined point in time is An, the step length estimating unit may calculate the step length Sn corresponding to a point in time when the average acceleration An is acquired according to an expression Sn=C×(An/NA)×NS.

In this way, specifically, it is possible to estimate the step length from the above expression.

In the aspect of the invention, the input distance information may be information input by a user or external data.

In this way, it is possible to use the information input by a user or the external data as the input distance information used in calculation of the reference step length.

In the aspect of the invention, the reference information acquiring unit may calculate reference average acceleration candidates based on the average acceleration in a signal value acquisition period and the number of steps detected in the signal value acquisition period, and when a reference information acquisition instruction is received, the reference information acquiring unit may acquire the reference average acceleration candidate correlated with the reference step length in the signal value acquisition period as the reference average acceleration.

In this way, it is possible to calculate reference average acceleration candidates in the signal value acquisition period and to determine whether the reference average acceleration candidates are used as the reference average acceleration based on the presence of the reference information acquisition instruction.

In the aspect of the invention, when the reference information acquisition instruction is received, the reference information acquiring unit may acquire the reference distance information of the running or the walking in the signal value acquisition period.

In this way, since the reference distance information is acquired when the reference information acquisition instruction is received, it is possible to calculate the reference step length or the like.

In the aspect of the invention, the reference distance information may be information input by a user or external data.

In this way, it is possible to use the information input by a user or the external data as the reference distance information used in calculation of the reference step length.

In the aspect of the invention, the average acceleration calculating unit may calculate the average acceleration in each of the predetermined periods set based on a point in time when steps are detected by the step detecting unit.

In this way, it is possible to calculate the average acceleration based on the step detection time.

In the aspect of the invention, the state detecting device may further include a filtering unit that performs a band-pass filtering process on the acceleration detection value; and a control unit that changes filter characteristics of the band-pass filtering process of the filtering unit, the step detecting unit may detect step cycle information based on the acceleration detection value after the band-pass filtering process, and the control unit may adaptively change the filter characteristics of the band-pass filtering process based on the step cycle information detected by the step detecting unit.

In this way, it is possible to perform a filtering process on the acceleration detection value and to adaptively change the characteristics of a filter used in the filtering process based on the step cycle.

In the aspect of the invention, the state detecting device may further include a distance information calculating unit that calculates distance information of running or walking based on the step length estimated by the step length estimating unit.

In this way, it is possible to calculate the distance information based on the estimated step length.

In the aspect of the invention, the state detecting device may further include a determining unit that determines whether the acceleration detection value indicates a running state or a walking state, and when the determining unit determines that the acceleration detection value indicates the running state, the distance information calculating unit may calculate the distance information based on the step length estimated by the step length estimating unit, and when the determining unit determines that the acceleration detection value indicates the walking state, the distance information calculating unit may calculate the distance information based on a predetermined step length.

In this way, it is possible to determine whether the acceleration detection value indicates the running state or the walking state and to determine the step length used in calculation of the distance information based on the determination result.

Another aspect of the invention is directed to a state detecting device including: an acquiring unit that acquires an acceleration detection value from an acceleration sensor; an average speed calculating unit that calculates an average speed in each predetermined period based on the acceleration detection value; a reference information acquiring unit that acquires a reference average speed and a reference step length; and a step length estimating unit that estimates a step length based on a ratio of the average speed to the reference average speed as well as the reference step length.

Still another aspect of the invention is directed to an electronic apparatus including the state detecting device according to the above aspect.

Yet another aspect of the invention is directed to a program for causing a computer to function as the respective units described above.

### BRIEF DESCRIPTION OF THE DRAWINGS

The invention will be described with reference to the accompanying drawings, wherein like numbers reference like elements.

FIG. 1 is a diagram illustrating an example of frequency characteristics of acceleration detection values.

FIG. 2 is a waveform diagram of an acceleration detection value before and after a filtering process.

FIG. 3 is a diagram illustrating a difference in the distance calculation accuracy according to the methods of the related art and an embodiment of the invention.

FIG. 4 is a diagram showing a system configuration example of an electronic apparatus or the like that includes a state detecting device according to the embodiment.

FIG. 5 is a diagram showing a system configuration example of the state detecting device according to the embodiment.

FIG. 6 is a diagram showing a configuration example of a filter used for a filtering process.

FIG. 7 is a diagram illustrating an average acceleration.

FIG. 8 is a diagram illustrating a distance calculation process when input distance information is acquired.

FIG. 9 is a flowchart illustrating a filtering process and an adaptive filter characteristics changing process.

FIG. 10 is a flowchart illustrating a walking and running determination process.

FIG. 11 is a flowchart illustrating a step length estimation process.

FIG. 12 is a flowchart illustrating a step length estimation process when input distance information is acquired.

FIG. 13 is a diagram illustrating a configuration example of a system that executes a program according to the embodiment.

### DESCRIPTION OF EXEMPLARY EMBODIMENTS

An embodiment of the invention will be described in detail. It should be noted that the embodiment described below does not disadvantageously restrict the content of the present invention recited in the scope of the appended claims. Moreover, it should be noted that not all of the constructions described with reference to the following embodiment are necessary as solving means of the present invention.

### 1. Method of Present Embodiment

First, a method according to the present embodiment will be described. A state detecting device according to the present embodiment is attached to a person (user) to detect a state regarding walking or running of the person. Specifically, the state detecting device detects the number of steps of walking or running and a step cycle (step frequency) based on a sensor signal from an acceleration sensor, determines a running state (whether the user is walking or running or the like), estimates a step length, and calculates distance information corresponding to the step length, etc.

In the related art, although a method of performing these processes by frequency analysis that uses FFT or the like has been proposed, it is difficult to detect the number of steps accurately and handle a change of the step frequency. It is also difficult to detect a change of the frame period of FFT. Thus, in the present embodiment, the processes are performed using an acceleration detection value rather than frequency analysis. That is, a temporal change of the acceleration detection value, for example, rather than a frequency axis is used.

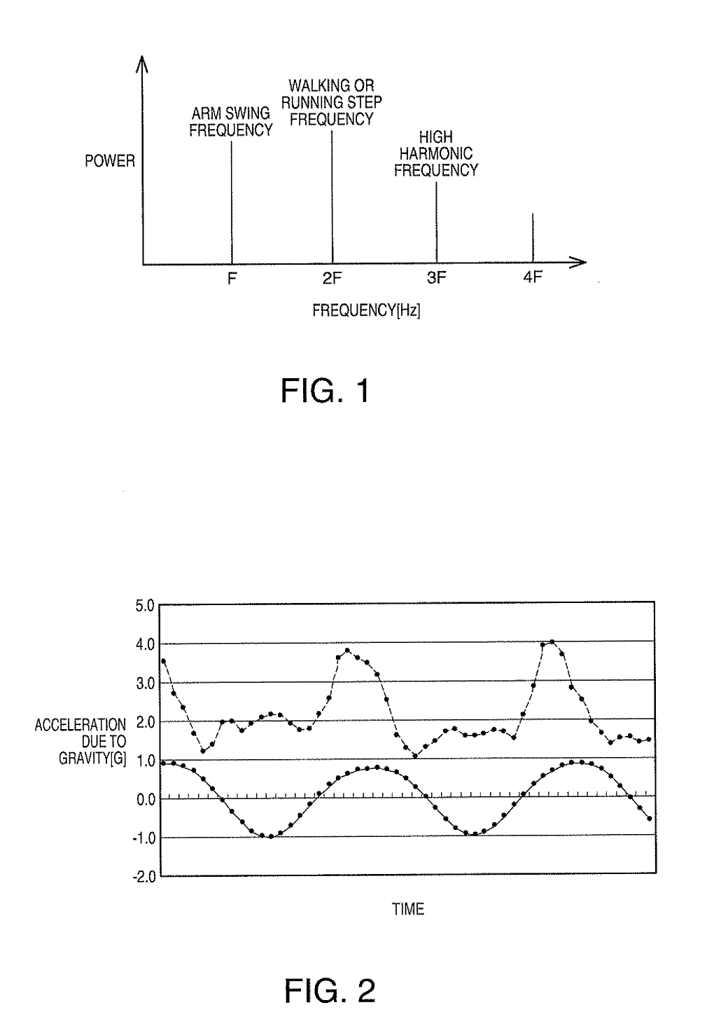

However, as shown in FIG. 1, the acceleration detection value also includes signals of various frequencies in addition to the step frequency that is intended to be processed. Thus, a temporal change of the acceleration detection value has a complex shape as indicated by a broken line in FIG. 2, for example. Therefore, a filtering process is performed rather than using the acceleration detection value as it is. Specifically, a filtering process of passing components of the step frequency and blocking components of the other frequencies may be performed. By doing so, it is possible to obtain a smooth signal waveform as indicated by a solid line in FIG. 2.

Here, another problem may occur when the step frequency changes. Although the step frequency corresponds to the pace of the walking or running of the user, the pace naturally changes even when the user intends to continue a constant exercise. When the exercise itself changes (from jogging to dashing or from walking to running), it is necessary to take a change of the pace into consideration. As described above, although the filtering process is to pass components of the step frequency and to block components of the other frequencies, if the step frequency changes, the correlation between a passband of a filter and the step frequency collapses.

Therefore, the present applicant proposes a method of adaptively changing the characteristics of a filter (in a narrow sense, frequency characteristics) used in a filtering process based on step cycle information (which may be a step cycle or a step frequency). By doing so, even when the step frequency changes, it is possible to perform a filtering process of passing components of the step frequency and blocking components of the other frequencies and to detect the state accurately. Specifically, the characteristics of the filter used in the filtering process may be changed at a subsequent point in time based on the step frequency detected in a certain point in time.

In the present embodiment, it is assumed that the acceleration sensor is attached to an arm portion (for example, the acceleration sensor is worn on a wrist like a wristwatch). This is due to the demand of users who want detected data to be viewed during exercise. For example, when the acceleration sensor is attached to a leg portion, and a display unit is provided to be integrated with the acceleration sensor, it may be difficult for the user to see the display unit during exercise. That is, the acceleration sensor needs to operate synchronized with other devices appropriate for display and viewing such as a wristwatch-type device, a head-mounted display, or a smart phone. Thus, it is necessary to frequently use a communication function or the like, which is disadvantageous from the power-saving perspective or the like. In this respect, when the acceleration sensor is attached to a wristwatch-type device, since no problem occurs even if a display unit is provided integrally, only internal processing is sufficient. However, it does not prevent communication with a host computer or the like that is provided as a separate unit.

However, when the acceleration sensor is attached to an arm portion, problems which do not occur when the acceleration sensor is attached to the leg portion need to be taken into consideration. When the acceleration sensor is attached to the leg portion, it is possible to directly obtain an acceleration detection value resulting from an exercise of the leg portion that is directly associated with the number of steps. Moreover, during walking or running of a person, since the step frequency of the walking or the like appears as peaks of a lowest frequency, a low-pass filter is sufficient for the filtering process of passing components of the step frequency and blocking components of the other frequencies. However, when the acceleration sensor is attached to an arm portion, since both the right and left legs move during one swing of the arm, frequency peaks corresponding the arm swing appear at a frequency with half the step frequency as shown in FIG. 1. That is, since components of the arm swing frequency are not blocked by the low-pass filter, it is necessary to use a band-pass filter.

Even when the process is performed based on an acceleration detection value of the frequency component corresponding to the arm swing frequency using a low-pass filter that passes components of the arm swing frequency and blocks components of the other frequencies, it is at least possible to detect steps and to estimate a step length. However, since one cycle of the arm swing corresponds to two steps of walking or running, it is only possible to perform the process in two respective steps. There is a high demand from users who want the number of steps to be counted every step. Taking this into consideration, it is preferable to perform the process using a band-pass filter rather than a low-pass filter when the acceleration sensor is attached to an arm portion.

Moreover, although it is possible to obtain a smooth acceleration signal waveform and detect steps or the like by performing the above-described filtering process, there is another problem in estimating a moving distance of the user caused by an exercise. In the related art, although a method of estimating the distance by taking the product between a step count number (number of steps) of walking or running and a step length has been proposed, the method is easy, whereas step length calculation accuracy is low, and distance estimation accuracy is low.

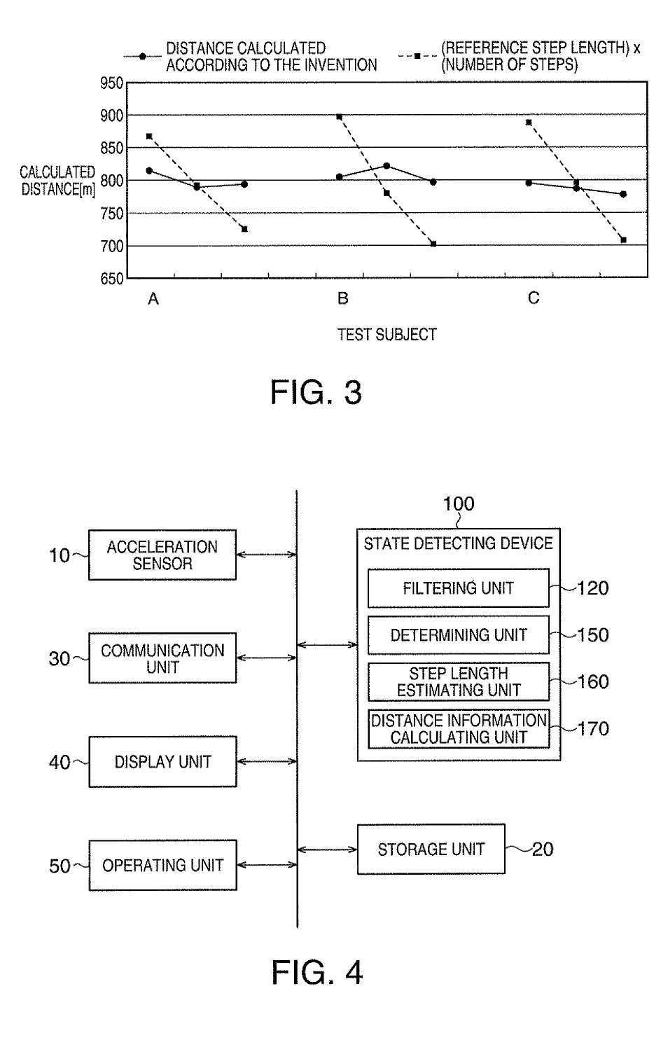

FIG. 3 shows distance estimation results when three users run a known distance (800 m) at three different speeds of high, medium, and low speeds, for example. In the figure, broken lines show the distance estimated from the product between a step length calculated based on an exercise result at the medium speed and a number of steps. As is clear from FIG. 3, although a value close to the correct answer (800 m) is obtained in an exercise at the same medium speed as when the step length is calculated, the estimation accuracy decreases greatly in an exercise at high and low speeds. This is because the step length increases in a high-speed exercise, the number of steps tends to decrease as compared to a medium-speed exercise, and thus, the moving distance is estimated to be small. Similarly, since the step length decreases in a low-speed exercise, and the number of steps tends to increase as compared to the medium-speed exercise, the moving distance is estimated to be large.

In contrast, although a method of estimating a step length based on a pace (step frequency) is proposed, since the relationship between the pace and the step length is not linear, and the influence of an individual difference is large, the method is not effective.

Therefore, the present applicant proposes a method of estimating a step length based on an average acceleration and reference information ([reference average acceleration]/[reference step length]) and calculating a moving distance based on the estimated step length. The details of the average acceleration and the like will be described later with reference to FIG. 7 and the like. The use of the method according to the present embodiment enables distance estimation accuracy to be improved. Specifically, solid lines in FIG. 3 are actual measurement values when the method of the present embodiment is used. It can be understood that a value close to the correct answer is obtained as compared to the method of the related art even when the exercise state (for example, a moving speed or the like) changes from the time of calculating the step length (reference step length) to the time of estimating the distance.

Hereinafter, first, a system configuration example will be described. Then, an adaptive filtering process, a walking and running determination process and a step length estimation process that use signals having been subjected to the filtering process whose characteristics are adaptively changed, and a distance information calculation process based on these processes will be described. Finally, the details of the respective processes will be described with reference to flowcharts.

### 2. System Configuration Example

FIG. 4 shows a configuration example of a state detecting device according to the present embodiment and an electronic apparatus that includes the state detecting device. The electronic apparatus (for example, a wristwatch-type device including a state detecting device) includes an acceleration sensor 10, a storage unit 20, a communication unit 30, a display unit 40, an operating unit 50, and a state detecting device 100. However, the electronic apparatus is not limited to the configuration of FIG. 4, and various modifications can be made in such a way that some of the constituent components are omitted (for example, the communication unit 30 may be omitted), or another constituent component is added.

The acceleration sensor 10 is a three-axis acceleration sensor, for example. The storage unit 20 is used as a working area of the state detecting device 100 or the like, and the function thereof can be realized by memory such as RAM, a HOD (hard disk drive) or the like. The storage unit 20 stores information that is assumed to be presented to the user, such as moving distance information of the user, calculated by a distance information calculating unit 170 and also stores internal information that is not assumed to be presented to the user, such as characteristic parameters of a filter used by the filtering unit 120.

The communication unit 30 performs communication with external apparatuses, and an example of the external apparatus is a host computer that analyzes the information detected by the state detecting device 100. The communication unit 30 is preferably realized wirelessly in order to allow communication in a state where the electronic apparatus is attached to the user, and may be realized by cables.

The display unit 40 displays various display screens and can be realized by a liquid crystal display or an organic EL display, for example. Although the display unit 40 displays information obtained by the state detecting device 100, the display unit 40 may display other types of information. For example, when the electronic apparatus is a wristwatch-type device, the display unit 40 may display time information. Moreover, when the display unit 40 is realized by a touch panel, the display unit 40 may display an interface for operations. In that case, a portion or an entire portion of the function of the operating unit 50 is realized by the display unit 40.

The operating unit 50 allows the user to perform various operations on the electronic apparatus and can be realized by various buttons or the like. Various buttons may be mechanical buttons and may be images displayed on a touch panel or the like.

The state detecting device 100 detects the state of the electronic apparatus (in a narrow sense, the user to which the electronic apparatus is attached). The state may be a state regarding a posture whether the user is standing or lying and may be a state regarding a movement whether the user is riding on a vehicle. In a narrow sense, the state may represent an exercise state represented by walking or running.

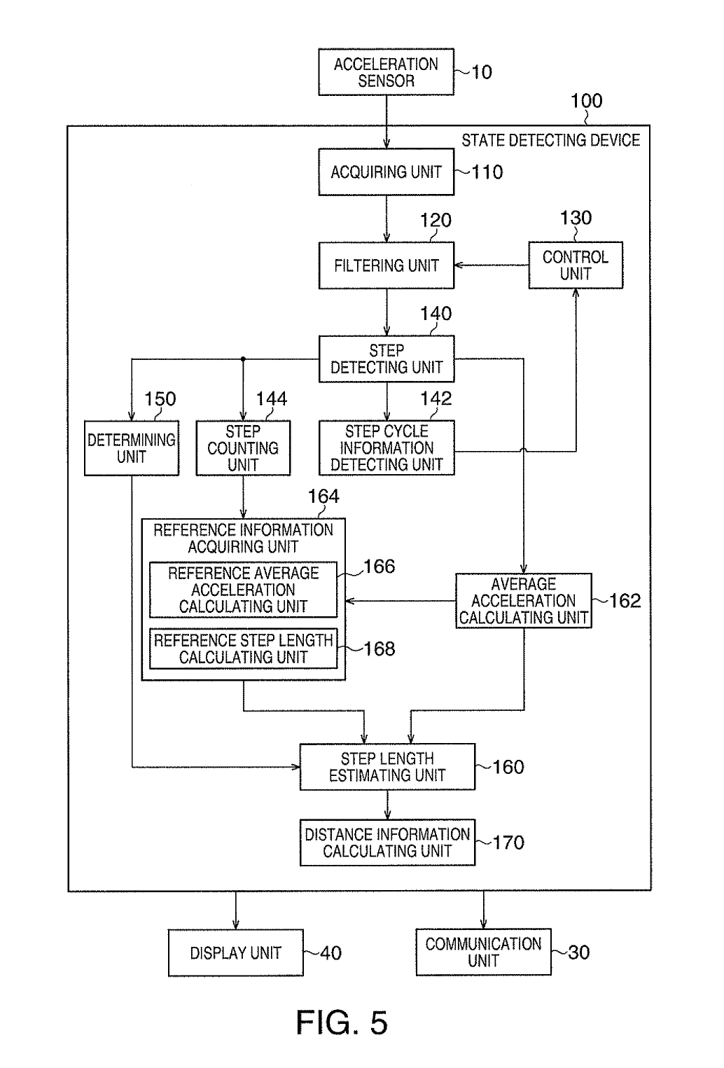

Next, a detailed configuration example of the state detecting device 100 will be described with reference to FIG. 5. As shown in FIG. 5, the state detecting device 100 includes an acquiring unit 110, a filtering unit 120, a control unit 130, a step detecting unit 140, a step cycle information detecting unit 142, a step counting unit 144, a determining unit 150, a step length estimating unit 160, an average acceleration calculating unit 162, a reference information acquiring unit 164, and a distance information calculating unit 170. The state detecting device 100 is not limited to the configuration of FIG. 5, and various modifications can be made in such a way that some of the constituent components are omitted, or another constituent component is added.

The acquiring unit 110 acquires sensor information from the acceleration sensor 10. When the acceleration sensor 10 is a three-axis acceleration sensor, the acquiring unit 110 acquires three values corresponding to the respective xyz axes. The acquiring unit 110 is configured as an interface between the acceleration sensor 10 and the state detecting device 100 and may output the sensor signal from the acceleration sensor to the filtering unit 120 as it is and may perform pre-processing when outputting the sensor signal to the filtering unit 120.

As the pre-processing, a process of calculating a combined acceleration by combining the three acceleration signal values of the xyz axes (for example, obtaining a square root of a square sum thereof) may be performed, a low-pass filtering process of removing acceleration resulting from landing of the user's leg may be performed, and both processes may be performed. The reason why the low-pass filtering process is performed is that walking or running is detected based on an acceleration resulting from a movement of the user's body, the acceleration resulting from a landing impact is a hindrance to the process and the landing impact acceleration mainly appears in high frequencies. Moreover, rather than calculating the combined acceleration, a process of transforming a coordinate into a coordinate system different from a sensor coordinate system and then obtaining values associated with specific axes may be performed.

In the present embodiment, the information input to the acquiring unit 110 from the acceleration sensor 10 is referred to as sensor information, and information output to the filtering unit 120 from the acquiring unit 110 is referred to as acceleration detection value. If the pre-processing is not performed at all, although the sensor information and the acceleration detection value exhibit the same information, in general, the sensor information and the acceleration detection value become different information because the above-described process, a noise reduction process, and the like are performed.

The filtering unit 120 performs a filtering process on the acceleration detection value output from the acquiring unit 110. In the present embodiment, since detection (determination) of walking or running, and subsequently, estimation of a step length, and the like are assumed, a filtering process of passing components of the step frequency corresponding to the pace of the walking or running of the user and blocking components of frequencies other than the step frequency may be performed. In the present embodiment, considering a case where a peak frequency that is to be blocked appears in frequencies lower than the step frequency (for example, a case where the acceleration sensor is attached to an arm portion), the filtering process is described as being a band-pass filtering process.

The control unit 130 controls the characteristics of a filter used by the filtering unit 120 based on the step cycle information (for example, the step frequency) output from the step cycle information detecting unit 142. The details thereof will be described later.

The step detecting unit 140 detects steps based on a signal having been subjected to the filtering process of the filtering unit 120. The steps correspond to the walking or running of the user and one step is detected whenever the user takes a step. The acceleration detection value after the filtering process can be approximated mainly to a sinusoidal wave of the step frequency components as indicated by the solid line in FIG. 2, and therefore a step detection signal may be output every cycle of the sinusoidal signal. Specifically, peaks (troughs) of the signal waveform may be detected, and the peaks can be detected by calculating difference values (inclinations) between the signal value at a target point in time and the signal value at the previous and subsequent points in time and calculating a zero-crossing point of the difference values. For example, a point at which the difference values between the signal values at adjacent points in time change from a positive (negative) value to a negative (positive) value may be detected as a peak (trough). Moreover, a difference value between the signal values before and after two points in time may be used as the difference value rather than calculating the same from the adjacent points in time. For example, when both a difference value from that of two points in time before and a difference value from that of one point in time before are positive (negative), and both a difference value from that of one point in time after and a difference value from that of two points in time after are negative (positive), the present point in time may be detected as a peak (trough).

Simply, the output from the step detecting unit 140 may be a pulse signal that informs of detection of steps. The pulse signal is information that output whether steps are detected or not, and the content of the information does not have to have a particular meaning. However, the step detecting unit 140 acquires the acceleration detection value after the filtering process in order to detect steps as described above. Thus, not only information that informs of detection of steps but also the magnitude of the acceleration detection value at that time (the magnitude is a peak acceleration value which is the peak acceleration detection value if steps are detected by detecting peaks) may be included in the output information. In other words, the acceleration detection value may be output at a point in time other than the time when steps are detected. In this specification, the output of the step detecting unit 140 is referred to as step detection information. The step detection information is output to the step cycle information detecting unit 142, the step counting unit 144, the determining unit 150, and the average acceleration calculating unit 162. The content of the step detection information may be different depending on each unit which may be an output destination, details of which will be described when each unit is described later.

The step cycle information detecting unit 142 detects step cycle information based on the step detection information from the step detecting unit 140. Here, the step cycle information may be a step cycle and may be a step frequency. The step detection information may be the pulse signal described above, a period from the input of a previous pulse signal to the input of a current pulse signal corresponds to the step cycle, and a reciprocal thereof corresponds to the step frequency. Moreover, the step cycle information may be different information that can be calculated based on the step cycle or the step frequency. The step frequency information is output to the control unit 130.

The step counting unit 144 counts steps. The value counted by the step counting unit 144 corresponds to the number of steps of the user. As a simple configuration, the step counting unit 144 may be a counter or the like that is incremented whenever the step detection information (in this example, the pulse signal) is input from the step detecting unit 140. Moreover, the step counting unit 144 does not have to be a simple counter but may perform other processes. For example, the step counting unit 144 may improve the detection accuracy of the number of steps by excluding the detected steps resulting from an exercise other than walking or noise.

The determining unit 150 determines whether the user is walking or running. The determination is performed based on the step detection information from the step detecting unit 140. Although the details are described later, the step detection information mentioned herein may include a peak acceleration value as well as the pulse signal.

The step length estimating unit 160 estimates the step length of the user. The step length is estimated based on [average acceleration]/[reference information]([reference average acceleration]/[reference step length]). Moreover, the determination result obtained by the determining unit 150 when estimating the step length may be used.

The average acceleration calculating unit 162 calculates an average acceleration based on the step detection information from the step detecting unit 140. The average acceleration corresponds to an average value of the acceleration detection values after the filtering process over a period from the detection of a certain step to the detection of the next step. Thus, the step detection information mentioned herein needs to include the acceleration detection values after the filtering process at points in time other than the time of detecting steps as well as the pulse signal. Thus, although not shown in FIG. 5, the average acceleration calculating unit 162 may be connected to the filtering unit 120 and may acquire the acceleration detection value after the filtering process directly from the filtering unit 120. In that case, the step detection information is sufficient to be as simple as the pulse signal.

The reference information acquiring unit 164 acquires reference information based on the average acceleration calculated by the average acceleration calculating unit 162, the step count number obtained by the step counting unit 144, and the like. The reference information acquiring unit 164 may include a reference average acceleration calculating unit 166 that calculates a reference average acceleration and a reference step length calculating unit 168 that calculates a reference step length. The respective units subsequent to the step length estimating unit 160 are associated with a step length estimation process, and details thereof will be described later.

The distance information calculating unit 170 calculates distance information (moving distance) resulting from the walking or running of the user based on the step length estimated by the step length estimating unit 160. The details thereof will be described later.

### 3. Adaptive Filtering

A filtering process on the acceleration detection value acquired by the acquiring unit 110 will be described. In this section, a case where the acceleration sensor is attached to an arm portion will be considered, and a process that uses a band-pass filter will be described as the filtering process. However, the attachment portion of the sensor is not limited to the arm portion.

The state detecting device according to the present embodiment acquires information on the walking or running of the user. However, since the acceleration detection value has peak values at frequencies other than the step frequency of the walking or running, a temporal change waveform of the acceleration detection value has a complex shape as indicated by the broken line in FIG. 2. For example, when the acceleration sensor is attached to an arm portion, if the step frequency is 2F, the peaks of the arm swing frequency appear at the half frequency F (since the arm swings once when the legs take two steps). Moreover, peaks appear at high frequencies such as 3F or 4F which are combined frequencies of the arm swing frequency and the step frequency.

Thus, the filtering unit 120 performs a band-pass filtering process of passing components of the frequency of 2F and blocking components of the other frequencies. However, it is not necessary to pass only the components of the frequency of 2F strictly. Due to a practical design of band-pass filters, although the passband has a certain width, even if the band-pass filter passes components of frequencies between F and 2F and frequencies between 2F and 3F, since no peak value appears in the frequency ranges, the influence on the subsequent processes is not large. That is, in a narrow sense, the band-pass filter may have characteristics of passing components of the frequency of 2F and blocking components of frequencies of F or lower and 3F or higher. Whether a component of a certain frequency is passed or blocked may be defined, for example, in such a way that components in a frequency range included in a passband determined by a cut-off frequency are passed, and components in the other frequency ranges are blocked.

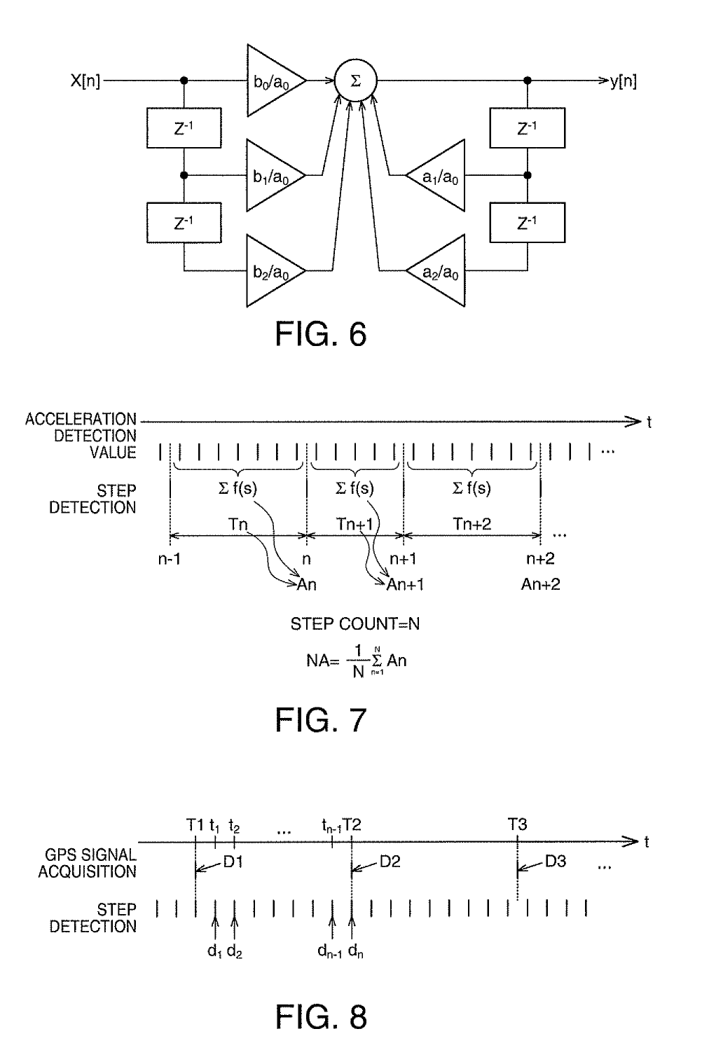

The band-pass filter may be configured as a general biquadratic filter (IIR filter) shown in FIG. 6, for example. This filter is expressed by Expression (1) below when an input value is x and an output value is y. Moreover, specifically, the filter coefficients in FIG. 6 are represented by Expressions (2) to (8) below.

y[n]=(b0/a0)*x[n]+(b1/a0)*x[n−1]+(b2/a0)*x[n−2]−(a1/a0)*y[n−1]−(a2/a0)*y[n−2] (1)

b0=α (2)

b1=0 (3)

b2=α (4)

a0=1+α (5)

a1=−2 cos(2πf) (6)

a2=1−α (7)

α=sin (2πf)/Q (8)

Here, “f” represents a center frequency of a band-pass filter, and “Q” represents a coefficient that determines a filter bandwidth. That is, by setting the values “f” and “Q”, it is possible to form various band-pass filters.

That is, the control unit 130 performs a process of calculating the step frequency from the output value from the step cycle information detecting unit 142 (alternatively, the step frequency itself may be output) and changing the value “f” in Expressions (1) to (8) into the step frequency.

In this way, it is possible to change the filter characteristics used by the filtering unit 120 based on the step frequency (a reciprocal of a step cycle which is a period between the detection time of steps one point in time before and the latest step detection time) obtained at the current point in time and to perform the filtering process at the subsequent points in time. Since the filter characteristics change adaptively based on the detected step cycle information, even when the step frequency changes during exercise, it is possible to perform an appropriate filtering process.

The value “Q” in Expression (8) may be a fixed value or may be changed adaptively based on the filter cycle information. However, the frequencies of F and 3F may not be included in the passband.

Moreover, in the present embodiment, since the filter characteristics change adaptively according to the exercise state of the user, it is necessary to determine predetermined filter characteristics when the user starts an exercise (when the system starts operating). Although the filter characteristics may be fixed values, the values preferably change according to an exercise if the exercise executed is known (for example, whether the user dashes a short distance or jogs a long distance). If the initial value is appropriately set, the subsequent filter characteristics can be adaptively set according to the method of the present embodiment.

The control unit 130 may change the filter characteristics every step (whenever the user takes one step) or every specific number of steps. When the filter characteristics are changed every step, a change of the step frequency can be dealt with at a high speed. Moreover, when the filter characteristics are changed every specific number of steps (for example, every ten steps), it is possible to decrease the processing frequency of the control unit 130 and to realize power saving. Moreover, depending on an attachment position of the acceleration sensor, an offset may occur in the step frequency between when the right leg steps forward and when the left leg steps forward. In such a case, the filter characteristics may be changed every specific number of steps (for example, every two steps) rather than every step. When the characteristics are changed every step even if there is an offset, although the processing may be complicated, two parameters of right and left-leg filtering parameters may be prepared and the parameter to be used may be changed depending on the leg that steps forward. In this case, the right-leg filtering parameter is updated using the step frequency when the right leg steps forward, and the left-leg filtering parameter is updated using the step frequency when the left leg steps forward.

### 4. Walking and Running Determination

Next, the walking and running determination process of the determining unit 150 will be described. In this section, the determination is performed simply based on the acceleration signal (that is mainly a sinusoidal wave of the step frequency) after the filtering process of the filtering unit 120.

For example, the determining unit 150 performs a process of calculating a peak acceleration which is a peak value of the acceleration and comparing the peak acceleration with a threshold value. When a first threshold value is Th1, a second threshold value is Th2 (<Th1), and the peak acceleration is smaller than Th2, it is determined that the user is not walking or running. This corresponds to an arm swing operation other than the walking or running such as when the user stops moving and moves their arms. Moreover, when the peak acceleration is equal to or greater than Th2 and smaller than Th1, it is determined that the user is walking. When the peak acceleration is equal to or greater than Th1, it is determined that the user is running.

Here, a value of approximately 0.2 (G) is assumed as Th2, and a value of approximately 0.5 (G) is assumed as Th1. Although a sensor value detected by an acceleration sensor may have a magnitude of approximately 10 (G), since a DC component is removed by the band-pass filtering process, the threshold value may be values in the above-described range.

Moreover, the walking and running determination may be performed using information on the step detection as well as the magnitude of the acceleration signal. For example, when the electronic apparatus including the state detecting device according to the present embodiment is a wristwatch-type device, since the electronic apparatus may include the display unit 40 as shown in FIG. 4, the user may refer to the information (a moving distance, a moving speed at that point in time or the like) displayed on the display unit 40 even during exercise. In that case, as in the case of reading the time on a wristwatch, it is expected that a relative position of the arm portion in relation to the body of the user is maintained to be constant to some extent, and the arm swing operation is not performed. Since the acceleration sensor is included in the wristwatch-type device and acquires an acceleration signal of the arm portion, if the arm swing operation is not performed, the magnitude of the acceleration signal decreases.

In such a case, if the user is walking or running, an acceleration resulting from such an exercise can be detected by the acceleration sensor. Thus, the sensor information has peaks at the step frequency 2F, and it is not necessary to change the above-described step detecting process, the step cycle information detecting process, the filter characteristics changing process of the control unit 130 or the like.

However, when the user watches the wristwatch-type device during running, although the running state is continued as an exercise, the acceleration detection value decreases, and it is determined in the threshold value determination that the user is in the walking state or in the stop state (a state that is not the running state or the walking state).

Therefore, taking such a case into consideration, the walking and running determination may be performed using information (for example, the step cycle) on the step detection in addition to the acceleration signal value. An example of a specific method will be described. In this example, to make the description simple, it is determined whether the user is in the walking state or in the running state, and the stop state is not taken into consideration. First, as a first process, a threshold value determination is performed using the magnitude of the acceleration signal value. The user is determined to be in the running state when the acceleration signal value is greater than the threshold value, and the user is determined to be in the walking state when the acceleration signal value is equal to or smaller than the threshold value. When the exercise state is not changed from the previous exercise state (running→running or walking→walking), and the exercise state shifts in the direction of a high-speed exercise (walking→running), the determination result of the threshold value determination is used as it is. As described above, since a decrease in the acceleration signal value as a result of the user watching the display unit 40 is a problem, if the acceleration signal value remains the same or changes in an increasing direction, it can be considered that the user does not watch the display unit 40.

In contrast, when the exercise state shifts in the direction of a low-speed exercise (running→walking), it is necessary to appropriately determine whether an exercise itself is really changed, and whether the user watches the display unit 40. Thus, in this case, the step cycle of the state just before is compared with the latest step cycle. For example, if the exercise itself of the user is changed from running to walking, the acceleration signal value may decrease and the step cycle may change (although the direction of the change is different depending on a user, in many cases, the step cycle of walking is longer than the step cycle of running, for example). That is, if the step cycle is changed to some extent, it is determined that the exercise itself is changed, and the walking state which is the result of the threshold value determination is used as it is. In contrast, if the change in the step cycle is small, since it can be considered that the same exercise state is continued, it is determined that the decrease in the acceleration signal value is caused by the user watching the display unit 40. In this case, the walking state obtained as the result of the threshold value determination is corrected to the running state.

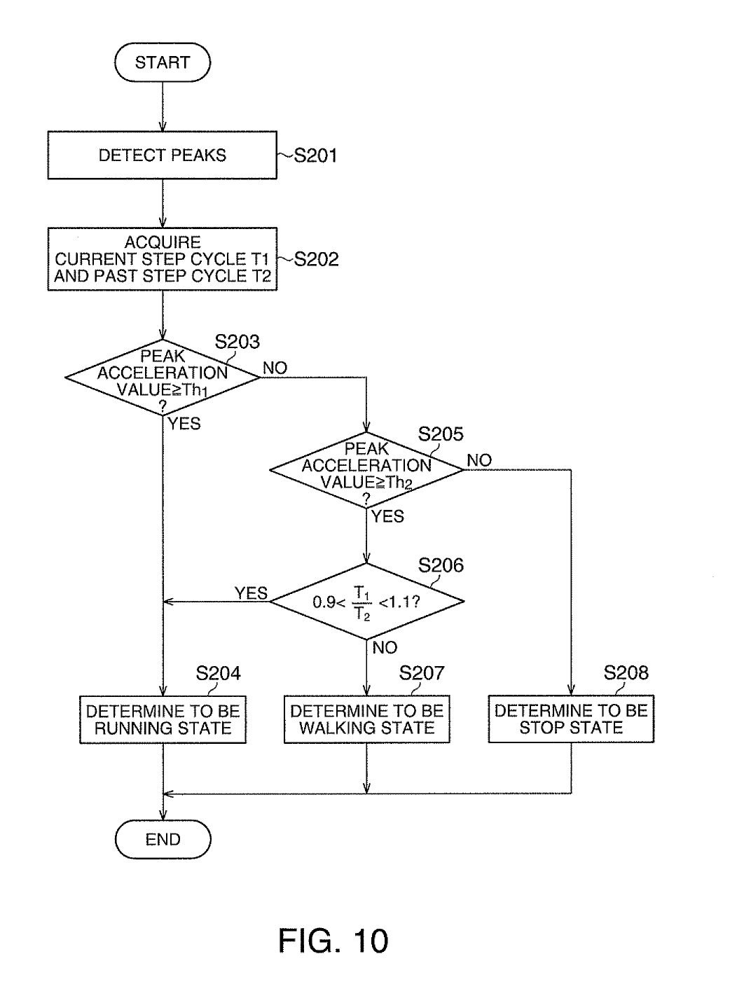

To make the process simple, the change in the exercise state does not have to be taken into consideration. That is, once the state of the user is determined to be the walking state, a determination process based on the step cycle may be performed regardless of whether the previous state of the user is the running state or the walking state. This example will be described with reference to the flowchart of FIG. 10.

### 5. Step Length Estimation and Distance Information Calculation Process

Next, a step length estimation process and a distance information calculation process based on an estimated step length or the like will be described. In the present embodiment, the step length of the user is estimated based on an average acceleration and reference information (a reference average acceleration or a reference step length).

### 5.1 Average Acceleration

First, an average acceleration used in the step length estimation of the present embodiment will be described. An average acceleration corresponds to an average value of acceleration signal values in a predetermined period. Specifically, the average acceleration calculating unit 162 calculates the average acceleration based on the acceleration detection value after the filtering process of the filtering unit 120 and the step detection information (pulse signal or the like) from the step detecting unit 140.

The details thereof will be described with reference to FIG. 7. The horizontal axis of FIG. 7 represents time. “Step Detection” in FIG. 7 corresponds to a point in time when steps are detected by the step detecting unit 140, and for example, is a point in time when the average acceleration calculating unit 162 receives the pulse signal from the step detecting unit 140. “n−1”, “n”, “n+1”, and the like correspond to the number of times when steps are detected, and for example, “n” is the n-th step detection time. Since the first step detection corresponds to one step of the user, the step detection rate is approximately 1 to 2 times per second, whereas the acquisition rate of the sensor information from the acceleration sensor is considered to be higher than the step detection rate. Thus, the output rate of the acceleration detection value from the filtering unit 120 is higher than the step detection rate, and the output points in time thereof correspond to the individual lines of the acceleration detection value in FIG. 7.

The average acceleration is an average value of acceleration detection values after the filtering process in a period from the step detection time one before to the target step detection time. That is, when the magnitude of an acceleration detection value is f(s), and the period from the (n−1)th step detection time to the n-th step detection time is Tn, an average acceleration “An” corresponding to the n-th step detection is expressed by Expression (9) below.

$$An = \frac{1}{Tn} {\sum }_{n - 1}^{n} f ( s ) \qquad ( 9 )$$

### 5.2 Calibration

Moreover, in the step length estimation of the present embodiment, a reference average acceleration which is a reference for the average acceleration and a reference step length which is a reference for the step length are used. The reference average acceleration as well as the reference step length may use predetermined values. However, the reference values of the average acceleration and the step length change between users, and the reference values for the same user change depending on an exercise state (whether the user is walking, jogging, or dashing). Thus, it is preferable to determine the reference values based on values which are obtained by actually performing walking or running. That is, a calibration may be performed to acquire the reference average acceleration as well as the reference step length by actually performing walking or running. In the step length estimation process of the present embodiment, as illustrated in FIG. 3, even when the exercise state (running speed) when the reference information is acquired is changed from the exercise state when the step length is estimated and the distance is calculated, it is possible to perform step length estimation and distance calculation with high accuracy. Thus, basically, although the exercise during the calibration is preferably equivalent to the exercise during step length estimation assumed later, the calibration is not limited to this, and the calibration may be performed in a slightly different exercise state.

An example of the calibration will be described. First, a mode is set to a calibration mode, and then, the user walks (runs) a known distance D (for example, if the user does one circuit of a 400-meter track, D is known (D=400 m)) and inputs the distance D. The acceleration detection value is acquired according to the walking or running, and steps are detected. Further, the step counting unit 144 counts a step count number N (number of steps) which is the number of times of step detection.

As described above, since the average acceleration is calculated every step detection time, the average acceleration calculating unit 162 acquires N average accelerations (A1 to AN) based on Expression (9) above by N step detection times. The 0-th step detection time may be the start time of a reference information acquisition period (for example, the period from the start to the end of walking or running of D=400 m). When D, N, and A1 to AN are given, the reference step length NS and the reference average acceleration NA are expressed by Expressions (10) and (11).

$$\begin{matrix}NS = \frac{D}{N} & ( 10 ) \\ NA = \frac{1}{N} {\sum }_{n = 1}^{N} An & ( 11 )\end{matrix}$$

That is, the reference step length NS is calculated by dividing the moving distance D by the number of steps N, and the reference average acceleration NA is calculated as an average value of A1 to AN.

### 5.3 Step Length Estimation and Distance Information Calculation

In the present embodiment, the step length estimation and distance information calculation process is performed using the reference information ([reference average acceleration]/[reference step length]) acquired before the process. The step length estimation process of the step length estimating unit 160 estimates the step length corresponding to the step in each step detection time. The step length corresponding to the step is estimated based on the NA and NS acquired in advance and the average acceleration An corresponding to the step. Specifically, when an average acceleration at the nth step detection (walking of the n-th step) as counted from the start of the process is An, and the estimated step length at that time is Sn, Sn is expressed by Expression (12) below.

$$Sn = C \cdot \frac{An}{NA} \cdot NS \qquad ( 12 )$$

Here, “C” is a coefficient determined according to a person or a running state. That is, the estimated step length can be calculated by the product of the ratio of the average acceleration to the reference average acceleration as well as the reference step length.

The distance information calculation process of the distance information calculating unit 170 may take the sum of estimated step lengths. In the present embodiment, since the step length of each step (that is, the moving distance of each step) is estimated, a total moving distance is the same as the sum of the estimated step lengths. The distance information calculation process may be changed based on the determination result of the determining unit 150. For example, when it is determined to be the running state, the distance information may be calculated using the estimation result of the step length estimating unit 160. When it is determined to be the walking state, the distance information may be calculated using a predetermined fixed value as the step length. This is because walking is a more stable operation than running, a change in the step length is small, and thus a great problem may not occur even when a fixed value is used.

### 5.4 First Modification Example (Modification Example of Calibration)

The calibration method is not limited to the above. In the above example, performing the calibration is known in advance, and it is not assumed that the step length estimation and distance information calculation are performed when performing calibration. For example, when the reference information is not stored such as when a user purchases and uses a product in which the state detecting device according to the present embodiment is included, the calibration described above is performed.

However, if the reference information is already stored, the calibration may be performed while performing the step length estimation and distance information calculation. As described above, even when the calibration is not performed, the average acceleration is calculated in order to estimate step length. Moreover, there may be case where the step count number N is also calculated because the step detection is essential. That is, since the values A1 to AN and N are acquired even during a normal use rather than calibration, it is possible to calculate the reference average acceleration as well as the reference step length if the moving distance D is known.

In the method of the present embodiment, since it is possible to estimate the moving distance by calculating the distance information based on the step length estimation, it is basically assumed that the user walks or runs an unknown distance (for example, jogs on a public road). However, since the device on which the state detecting device according to the present embodiment is mounted can present other items of information such as a moving speed or the number of steps, it can be sufficiently considered that the device is attached to a user who runs or walks a known distance (for example, running on a track).

In such a case, the user can perform calibration by inputting the moving distance D of the user into the device after ending running or walking. As described above, this is because the average accelerations A1 to AN and the step count number N are acquired during exercise, and thus it is possible to calculate the reference average acceleration as well as the reference step length according to Expressions (10) and (11) using the input moving distance D.

5.5 Second Modification Example (Step Length Estimation and Distance Information Calculation when Reference Distance Information is Acquired)

The state detecting device according to the present embodiment may be used together with an external apparatus that acquires reference distance information. The reference distance information is information on the moving distance of the user, and the accuracy of the value is expected to be higher than the distance information calculated based on the step length estimation according to the present embodiment. As an external apparatus, a GPS or the like can be used, for example.

Since the use of a GPS enables the position information of the user to be acquired, it is possible to calculate the moving distance of the user based on a change in the position information. Although the use of the GPS enables accurate distance information to be calculated, when the distance information is calculated only by the GPS, the distance information is not updated at all in a period between a GPS signal acquisition time and the next GPS signal acquisition time. That is, it is necessary to acquire signals from then GPS frequently in order to calculate the moving distance more accurately. However, there is a problem in that the GPS generally consumes a large amount of power, and the device operable period decreases if signals are acquired frequently. In particular, when the state detecting device of the present embodiment is incorporated into the wristwatch of the related art, since the wristwatch is requested to operate continuously for several thousand to several tens of thousand hours, the power consumption caused by the GPS operation or the like is not negligible.

Therefore, this problem may be solved by using the method of the present embodiment as an auxiliary method. That is, the power consumption can be decreased by lowering the signal acquisition rate of the GPS. Accordingly, since a period when the GPS signal is not obtained (that is, a period when the moving distance is not updated) increases, the moving distance is calculated in that period according to the method of the present embodiment.

Specifically, the values NS and NA are acquired earlier than a first point in time when the GPS signal is acquired. Moreover, the acceleration detection value is acquired in a period between the first point in time and a second point in time which is the next GPS signal acquisition time, and the moving distance is calculated based on Expressions (9) and (12).

A specific example is shown in FIG. 8. The horizontal axis of FIG. 8 represents the time and also illustrates a GPS signal acquisition time and a step detection time. In FIG. 8, in order to make description simple, although the GPS signal acquisition time is identical to one of the step detection times, this is not generally the case.

First, in time T1, a GPS signal is acquired and is compared with the GPS signal acquired before the time T1 to thereby calculate reference distance information D1 that represents a moving distance from a reference position (for example, the position when the user starts walking or running). Since the next GPS signal is not acquired until the time T2, the distance information is calculated based on the step length estimation in the period of T1 to T2. If steps are detected at the points in time of T1 and t1, it is possible to calculate a step length d1 corresponding to one step during the period of T1 and t1 according to Expressions (9) and (12) above based on the acceleration detection value during that period. In this case, the moving distance from the reference position at the time t1 can be calculated as D1+d1. Similarly, if a step is detected at the time t2 subsequent to the time t1, the step length d2 during the period of t1 to t2 is calculated according to the above-described method, and the moving distance is calculated as D1+d1+d2. The moving distance up to the time T2 may be calculated as D1+Σd.

When the next GPS signal is acquired at the time T2, reference distance information D2 that represents a moving distance from the reference position at the time T2 is calculated using the past GPS signal or the like. In this example, since calculation of moving distance information based on the GPS signal is considered to provide better accuracy, the moving distance obtained based on the step length estimation is assumed to be reset at the point in time when the GPS signal is obtained. In the example of FIG. 8, although two moving distances of “D1+Σd” and “D2” can be considered as the moving distance from the reference position at the time T2, D2 which is more accurate is employed.

Moreover, the difference value from D2 may be calculated in the period of T2 to T3 based on step length estimation to calculate the moving distance information. When the GPS signal is acquired at time T3, D3 is employed as the moving distance. The same applies to the subsequent periods.

5.6 Third Modification Example (Example where Reference Average Speed is Used)

Hereinabove, the process that uses the average acceleration and the reference average acceleration has been described. However, the method of the present embodiment is not limited to this, and the average speed and the reference average speed may be used.

Specifically, if the acceleration signal f(s) after the band-pass filtering process is acquired, a speed signal g(s) at a point in times is expressed as Expression (13) below when a sampling cycle of the acceleration signal is dt.

g(s)=f(s)·dt+g(s−1) (13)

In this way, it is possible to acquire a speed signal g(s) at the same point in time as the acceleration signal f(s). Thus, the average acceleration Vn can be calculated by Expression (14) below similarly to Expression (9) above.

$$Vn = \frac{1}{Tn} {\sum }_{n - 1}^{n} g ( s ) \qquad ( 14 )$$

Since the reference average speed is expressed as Expression (15) below similarly to Expression (11) above, the step length is calculated by Expression (16) below similarly to Expression (12) above.

$$\begin{matrix}NV = \frac{1}{N} {\sum }_{n = 1}^{N} Vn & ( 15 ) \\ Sn = C \cdot \frac{Vn}{NV} \cdot NS & ( 16 )\end{matrix}$$

### 6. Detailed Process

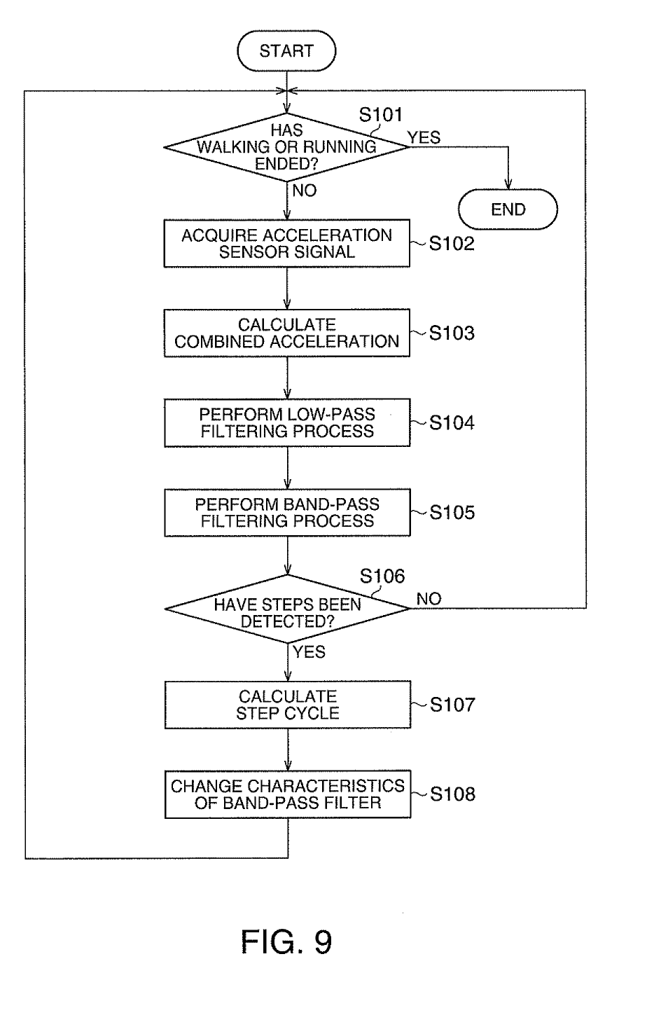

Details of the above-described respective processes will be described with reference to FIGS. 9 to 12.

### 6.1 Adaptive Filtering Process

Details of the adaptive filtering process will be described with reference to FIG. 9. When the process starts, first, it is determined whether the user is walking or running (S101). This is an ending condition of the process, and if a positive determination result is obtained, the adaptive filtering process ends. If a negative determination result is obtained in step S101, the sensor signals from the acceleration sensor are acquired (if a three-axis acceleration sensor is used, three sensor signals of the three axes of x, y, and z are acquired) (S102).

The acquired sensor signals are combined (for example, the square root of a square sum of the x, y, and z-axis signals is obtained), and a combined acceleration is calculated (S103). By performing a low-pass filtering process on the calculated combined acceleration, an acceleration component resulting from a landing impact is removed (S104).

Moreover, a band-pass filtering process is performed on the signals after the low-pass filtering process using a band-pass filter that has predetermined characteristics (S105). It is determined whether a step corresponding to the step of the user has been detected based on the signals after the band-pass filtering process (S106). If the step is not detected, the flow returns to step S101, and the acquisition of sensor signals and the filtering process are repeated. When the step is detected in step S106, the step cycle is calculated (S107), and the characteristics of the band-pass filter are changed based on the calculated step cycle (S108). Specifically, a period between the latest step detection time and one step detection time before may be used as the step cycle, and the frequency characteristics of the band-pass filter may be changed so that a step frequency which is a reciprocal of the step cycle becomes the center frequency.

In FIG. 9, although the characteristics of the band-pass filter are changed every step detection time, the characteristics of the band-pass filter may be changed once in multiple step detection times.

### 6.2 Walking and Running Determination Process

Details of the walking and running determination process will be described with reference to FIG. 10. When this process starts, first, the peak value (peak acceleration value) of the acceleration detection values are assumed to after the filtering process is detected (S201). Although this step detects the peak or the trough of the temporal change waveform of the acceleration detection value, the peak detected in the flowchart of FIG. 10 is assumed to be the peak. If the trough is used, since the peak values are assumed to have a negative value, it is necessary to invert the signs or take the absolute values.

Moreover, the step cycle T1 corresponding to the point in time when the peak acceleration value is detected and the step cycle T2 corresponding to a point in time earlier than the point in time are acquired (S202). The step cycles T1 and T2 may be calculated by the determining unit 150 based on the step detection in the step detecting unit 140, and the values detected by the step cycle information detecting unit 142 may be acquired by the determining unit 150. Moreover, although the step cycle T2 corresponds to a step cycle of one point in time before, of the step cycle T1, the step cycle T2 is not limited to this, but the value may be calculated using the values of previous several steps.

The walking and running determination is first performed based on the peak acceleration value. The peak acceleration value is compared with the threshold value Th1 (for example, 0.5 G). When the peak acceleration value is equal to or greater than Th1, it is determined to be the running state (S204), and the process ends.

Moreover, when the peak acceleration value is smaller than Th1 (S203: No), the peak acceleration value is compared with the threshold value Th2 (for example, 0.2 G) that is smaller than Th1 (S205). When the peak acceleration value is smaller than Th2, it is determined to be the stop state (S208), and the process ends.

When the peak acceleration value is smaller than Th1 and is equal to or greater than Th2, the determination is performed using the step cycles T1 and T2 acquired in step S202. Specifically, it is determined whether a change in T1 to T2 falls within a range of predetermined threshold values. For example, if an allowable change is 10%, it may be determined whether T1/T2 falls within a range of 0.9 to 1.1 (S206).

When the change in the step cycle is small (S206: Yes), even though the actual exercise state corresponds to the running state, it is determined that the peak acceleration value decreases with the arm swing being not performed by the user watching the display unit 40 of the wristwatch-type device or the like. Then, the flow proceeds to step S204, it is determined to be the running state, and the process ends. Moreover, when the change in the step cycle is large (S206: influenced by the user watching the wristwatch-type device or the like (that is, the peak acceleration value has a small value due to a change in the exercise state), it is determined to be the walking state (S207), and the process ends.

### 6.3 Step Length Estimation and Distance Information Calculation Process

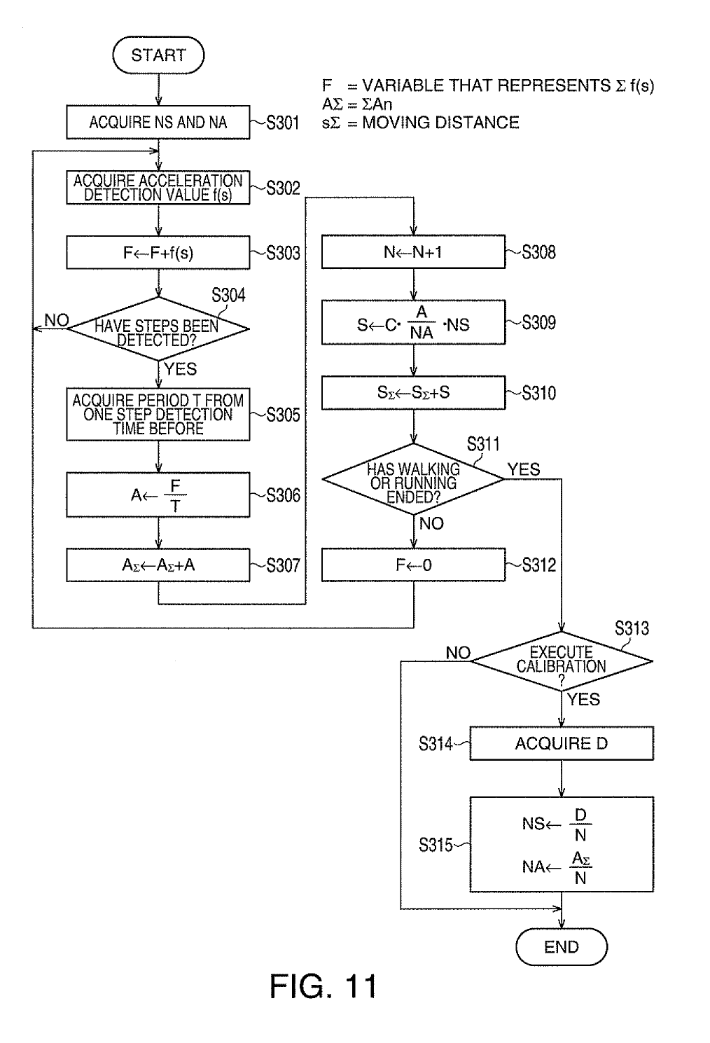

Details of the step length estimation and distance information calculation process will be described with reference to FIG. 11. FIG. 11 corresponds to the process from the start to the end of the walking or running. When this process starts, first, the reference average acceleration NA as well as the reference step length NS are acquired (S301). As described above, it is assumed that the values acquired by the reference information acquiring unit 164 at the points in time earlier than the current process are used as the values of NA and NS.

Subsequently, the acceleration detection value f(s) is acquired. The f(s) is the acceleration detection value having been subjected to the band-pass filtering process of the filtering unit 120, and for example, is acquired at a rate corresponding to a sensor information acquisition rate of the acceleration sensor. That is, the acquisition rate of the acceleration detection value is higher than the step detection rate in the step detecting unit 140. Moreover, a cumulative sum of f(s) is calculated (S303) (in FIG. 11, “F” is a variable that represents a cumulative sum).

Then, it is determined whether a step is detected (S304), and if the step is not detected, the flow returns to step S302, and the acquisition of f(s) and the calculation of the cumulative sum are repeated. As described later in step S312, since the value “F” is initialized after the step detection, the value “F” corresponds to the sum of the acceleration detection value f(s) in a period from a certain step detection time to the next step detection time.

When the step is detected, a period “T” from one step detection time before to the corresponding step detection time is acquired. Here, the period “T” corresponds to the step cycle.

Moreover, an average acceleration “A” corresponding to the latest step is calculated as A=F/T (S306). The processes in S303 and S306 correspond to Expression (9) above. Further, A_{Σ} which is a cumulative sum of the average acceleration from the start of the walking or running is calculated (S307), and a variable N that represents the step count number (corresponding to the number of steps) is incremented (S308).

After that, the step length S corresponding to the latest step is calculated from Expression (12) above (S309), and S_{Σ} which is a cumulative sum of the step length S from the start of the walking or running is calculated (S310).

By the processes up to S310, since various items of information are acquired, the information may be displayed on the display unit 40 at this point in time (not shown in FIG. 11). For example, N that represents the number of steps, S_{Σ} that represents the moving distance from the start of the walking or running, and the like may be displayed.

Moreover, it is determined whether the walking or running has ended (S311), when the walking or running has not ended, the value “F” is initialized (S312), and the flow returns to S302. Since the value “F” represents the sum of acceleration detection values between adjacent steps, the value “F” needs to be initialized in step S312. In contrast, since the values N, A_{Σ}, and S_{Σ} are values that are meaningful for a cumulative sum from the walking or running, these values need not be initialized. Moreover, since the values A and S are values acquired every step, these values may be initialized at the point in time of S312. However, since these values are overwritten in steps S306 and S309, these values need not be initialized necessarily.

When it is determined in step S311 that the walking or running has ended, it is determined whether calibration will be executed (S313). When calibration is not to be performed, the process ends. When calibration is to be performed, an accurate moving distance D of walking or running is acquired (S314), and the reference average acceleration NA as well as the reference step length NS are acquired from Expressions (10) and (11) above (S315). The values NA and NS acquired in this step are used in the subsequent walking or running.

In order to perform step length estimation (and distance information calculation) accurately, the data used for the calibration needs to be as accurate as possible. Thus, in FIG. 11, although the value S_{Σ} is the estimated moving distance, since the value S is an estimated value and accuracy is not guaranteed, the value S_{Σ} is not considered to be used as the value D acquired in step S314. The value D is a known distance that is input by the user, for example.

### 6.4 Modification Example of Step Length Estimation and Distance Information Calculation Process

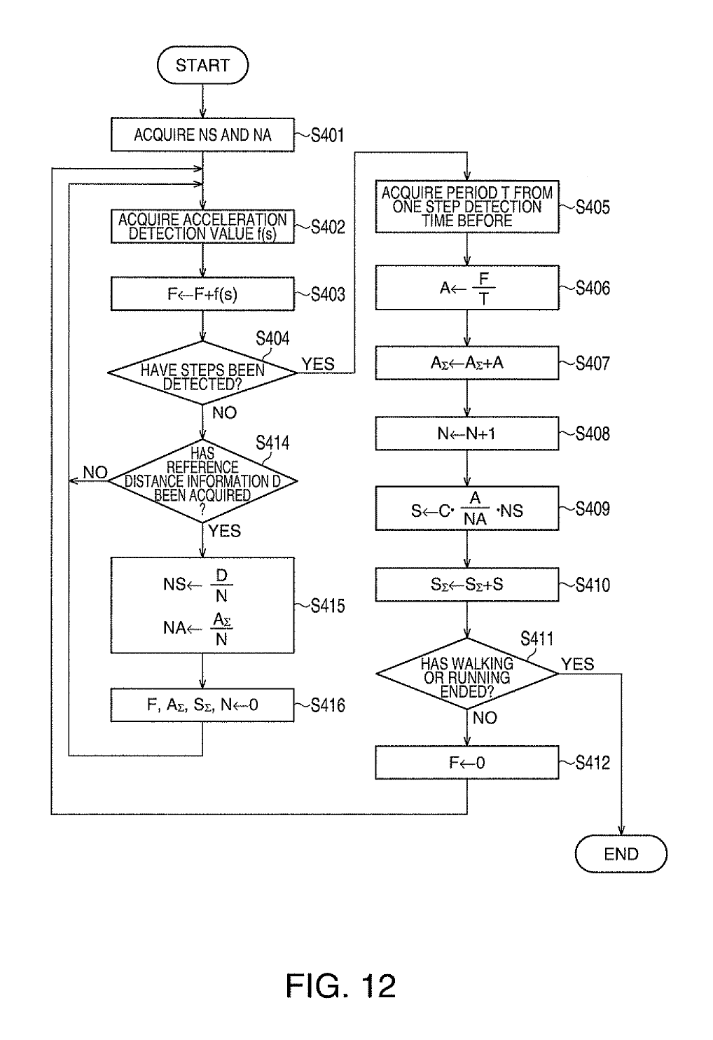

A modification example of the step length estimation and distance information calculation process will be described in detail with reference to FIG. 12. FIG. 12 is an example in which a reference moving distance (reference distance information) can be acquired by a certain means, and corresponds to a case where the GPS signal is acquired, for example.

The processes of steps S401 to S404 are the same as those of steps S301 to S304, and detailed description thereof will not be provided. Moreover, the processes of steps S405 to S412 in the “Yes” branch of step S404 are the same as the processes of steps S305 to S312 in the “Yes” branch of step S304.

When a positive determination result is obtained in step S411, that is, when the walking or running has ended, the process of calibration is not performed but the process ends unlike the flowchart of FIG. 11.

When the step is not detected in step S404, it is determined whether reference distance information D (for example, distance information based on a GPS signal) is acquired (S414). When the reference distance information is not acquired, the flow returns to step S402. When the information D is acquired, the information D represents the moving distance from the time when the previous reference distance information was acquired and has higher accuracy than the distance information calculated by a method that is based on step length estimation. Thus, it is possible to perform calibration using the acquired information D and the step count number N and the cumulative sum A_{Σ} of the average accelerations at that point in time (strictly speaking, the period from the time when the previous reference distance information was acquired to the current time) (S415).

In the flowchart of FIG. 12, since the calibration is performed whenever reference distance information is acquired, necessary variables are initialized so as not to affect the next calibration (S416), and the flow returns to step S402.

In this example, calibration may be appropriately performed even when there is no explicit calibration instruction or the like. Moreover, since the reference distance information is considered to be more reliable than the distance information calculated based on the step length estimation, the moving distance is calculated based on the acquired reference distance information at the point in time when the reference distance above information is acquired (details thereof have been described above with reference to FIG. 8). Moreover, in a period when the reference distance information is not acquired, the distance information is calculated based on the step length estimation by calculating the difference value from the reference distance information. That is, the values A_{Σ}, N, and S_{Σ} respectively obtained in steps S407, S408, and S410 are reset when the reference distance information is acquired. Thus, if the values obtained in the period from the start to the end of the walking or running are necessary, it is necessary to prepare other variables that store the respective values (the value N that corresponds to the number of steps is considered to be necessary).

### 6.5 Detailed Processing

In the present embodiment described above, as shown in FIG. 5, the state detecting device 100 includes the acquiring unit 110 that acquires the acceleration detection value from the acceleration sensor 10, the average acceleration calculating unit 162 that calculates the average acceleration in each predetermined period based on the acceleration detection value, the reference information acquiring unit 164 that acquires the reference average acceleration as well as the reference step length, and the step length estimating unit 160 that estimates the step length. The step length estimating unit 160 estimates the step length based on the ratio of the average acceleration to the reference average acceleration as well as the reference step length. The predetermined period may be set based on the point in time when the step is detected by the step detecting unit 140, and the average acceleration may be calculated in each of the set predetermined periods.

Here, the predetermined period is preferably a period (one step) from a certain step detection time to the next step detection time. This is because it is possible to calculate the moving distance of one step (walking of one step) as the step length and to estimate the moving distance finely. However, the average acceleration may be calculated every multiple steps and the moving distance may be estimated in respective multiple steps.

Moreover, the average acceleration corresponds to the average value of the acceleration detection values in the predetermined period. Specifically, the average acceleration has been described with reference to FIG. 7 and corresponds to Expression (9) above. In Expression (9) above, the acceleration detection value is divided by a period Tn that represents the predetermined period rather than by the number of acceleration detection values in the predetermined period. This is because the acceleration detection value is assumed to be acquired every constant period unlike the step detection. Moreover, the reference average acceleration is information that is a reference for the average acceleration, as well as the reference step length is information that is a reference for the step length.

Specifically, first to M-th (M is an integer of 2 or more) periods are set, and the i-th (1≦i≦M−1) period is a period that is earlier than the (i+1) th period. In this case, the state detecting device 100 according to the present embodiment includes the reference information acquiring unit 164 that acquires the reference average acceleration as well as the reference step length in periods earlier than the i-th period, the acquiring unit 110 that acquires the acceleration detection value in the i-th period from the acceleration sensor 10, the average acceleration calculating unit 162 that calculates the average acceleration in each period included in the i-th period based on the acceleration detection value, and the step length estimating unit 160 that estimates the step length corresponding to walking or running in the i-th period. The step length estimating unit 160 estimates the step length based on the ratio of the average acceleration to the reference average acceleration as well as the reference step length. The respective first to M-th periods correspond to the period from the start to the end of calibration or the period from the start to the end of exercise that is subjected to the step length estimation. Moreover, as described above, both the step length estimation and the calibration may be performed in one period.

In this way, it is possible to perform the step length estimation process based on the average acceleration, the reference average acceleration, as well as the reference step length. Specifically, the reference average acceleration and the average acceleration are used in a form of a ratio. That is, the value of the step length estimated changes depending on whether a change in the average acceleration in relation to the reference average acceleration is large or small and whether the change changes in a positive or negative direction. Moreover, in order to change the step length estimated according to the ratio, it is preferable that the reference value before change is set, and in the present embodiment, the reference step length is used. In the related art in which the step length is estimated based on a pace, due to a reason that the pace and the step length are not linear or the like, the accuracy of the estimated step length is low. In contrast, according to the present embodiment, it is possible to perform step length estimation with high accuracy as shown in FIG. 3.

Moreover, the state detecting device 100 may include the step detecting unit 140 as shown in FIG. 5. Moreover, the reference information acquiring unit 164 (in a narrow sense, the reference step length calculating unit 168 included in the reference information acquiring unit 164) acquires the reference step length based on the input distance information and the number of steps detected by the step detecting unit 140 in the reference information acquisition period. The input distance information may be information input by a user or external data. Moreover, in the description of FIG. 5 and the like, the step detecting unit 140 detects steps, the step counting unit 144 detects the number of steps, and the step cycle information detecting unit 142 detects the step cycle. However, these respective units do not have to be independent but may be configured by one block as a step detecting unit in a broad sense. In the following description, it is assumed that the step detecting unit 140 is a step detecting unit in abroad sense and detects the number of steps and the step cycle information as well as the step.

The step detecting unit 140 according to the present embodiment may detect the step or the like of the running or walking of the user. That is, the state detecting device 100 according to the present embodiment may include the step detecting unit 140 that detects at least the number of steps of the running or walking (for example, detects the step of running or walking, the number of steps, and the step cycle information), and the reference information acquiring unit 164 may acquire the reference step length based on the input distance information and the number of steps detected by the step detecting unit 140 in the reference information acquisition period.

Here, the step corresponds to a unit movement of an object to which the acceleration sensor 10 is attached. For example, when the acceleration sensor 10 is attached to a person (user) and the state detecting device 100 detects the step or the like of the running or walking of the user, the step corresponds to the walking of the user, and the step is detected once when the user takes one step of walking. Moreover, in the present embodiment, although the step is assumed to be associated with running or walking, the step in a broad sense is not limited to this. When the acceleration sensor 10 is attached to a vehicle (or a user riding on the vehicle), the step corresponds to a unit operation of the operation of the vehicle. For example, if the vehicle is a car, the step may correspond to a rotation of an engine mounted on the car. Specifically, if the engine is a gas-turbine engine, one rotation of the turbine may correspond to one step.

Moreover, the reference information acquisition period is a period for acquiring the reference information, and for example, may be the period from the start to the end of the walking or running. The input distance information is the distance information that is input by a user, an external apparatus, or the like and is information corresponding to the moving distance of the user in the reference information acquisition period. The number of steps represents the number of steps detected in the reference information acquisition period.

As a typical example, walking or running that mainly aims for calibration (acquisition of reference information) may be considered. That is, in this case, it is not necessary to perform step length estimation. For the calibration, the user runs a known distance (for example, 800 m), and inputs the known distance as the input distance information. In this case, the reference information acquisition period is the period from the start to the end of running of 800 m.

In this way, it is possible to calculate the reference step length based on the input distance information and the number of steps. Specifically, when the input distance information is D and the number of steps is N, the reference step length NS may be expressed by Expression (10) above. That is, the moving distance per step is calculated by dividing the moving distance by the number of steps and is used as the reference step length. Since the reference step length is used for the step length estimation during subsequent exercise, an appropriate value needs to be set. The input distance information preferably reflects the moving distance of the user in the reference information acquisition period accurately. Thus, the input distance information may be information input by a user inputting a known distance or may be highly accurate external data obtained by an external apparatus (for example, GPS).

Moreover, the reference information acquiring unit 164 (in a narrow sense, the reference average acceleration calculating unit 166 included in the reference information acquiring unit 164) may acquire the reference average acceleration based on the average acceleration and the number of steps acquired in the reference information acquisition period.

In this way, it is possible to calculate the reference average acceleration from the average acceleration and the number of steps. The reference information acquisition period may be the period from the start to the end of the walking or running or a period determined based on the external data acquisition time. Thus, the number of steps (number of steps) N detected in the reference information acquisition period generally has a certain magnitude to some extent and is an integer of at least 2 (although N may be 1, in that case, the reliability of the calculated reference information may be not guaranteed). Moreover, since the average acceleration is assumed to be calculated every step, N average accelerations of A1 to AN are acquired in the reference information acquisition period. Information that can be used as a reference for the average acceleration may be calculated based on these values N and A1 to AN and be used as the reference average acceleration. For example, as shown in Expression (11) above, the average value of the values A1 to AN may be calculated.

Moreover, when the reference average acceleration is NA, the reference step length is NS, the coefficient is C, and the average acceleration acquired at a predetermined point in time is An, the step length estimating unit 160 may calculate the step length Sn corresponding to the point in time when the average acceleration An is acquired according to an expression Sn=C×(An/NA)×NS.

In this way, it is possible to estimate the step length based on Expression (12) above. That is, if the coefficient C is not taken into consideration, when the average acceleration An is identical to the reference average acceleration NA, the step length Sn is the same as the reference step length NS. If An is k times NA, Sn is also k times NS. Thus, in the related art that uses a pace, since the pace and the step length are not linear, although sufficient accuracy is not obtained, by using the average acceleration, it is possible to estimate the step length by a simple computation having linearity. Here, “C” is the coefficient determined depending on an exercise state and an individual difference, and by appropriately setting the coefficient C, it is possible to improve the accuracy further.

Moreover, the reference information acquiring unit 164 may calculate the reference average acceleration candidate based on the average acceleration and the number of steps in the signal value acquisition period. Moreover, when a reference information acquisition instruction is received, reference average acceleration candidates are acquired as the reference average acceleration. In this case, the acquired reference average acceleration is correlated with the reference step length in the signal value acquisition period, acquired based on the reference information acquisition instruction. When the reference information acquisition instruction is received, the reference information acquiring unit 164 acquires reference distance information that represents the moving distance of the running or walking in the signal value acquisition period. The reference distance information may be information input by a user or external data.

Here, the signal value acquisition period is a period for acquiring a signal value (in a narrow sense, the sensor information of the acceleration sensor), and for example, is the period from the start to the end of the walking or running. The reference information acquisition instruction is an instruction that requests for acquisition of the reference information, and may be issued by the user operating the operating unit 50 or may be issued based on a signal from an external apparatus. The reference information acquisition instruction may involve an input of the reference distance information corresponding to the moving distance of the user in the signal value acquisition period.

In this way, it is possible to acquire the reference information based on the average acceleration which is acquired with a main aim for the step length estimation. As a typical application example of the state detecting device 100 according to the present embodiment, first, calibration that does not involve step length estimation may be performed in an exercise in the reference information acquisition period to acquire the reference information, and step length estimation may be performed in the subsequent exercise (each exercise is performed in the signal value acquisition period) using the acquired reference information (in this case, the calibration is not performed). If it is desired to update the reference information, calibration that does not involve step length estimation is performed again. That is, according to a typical example, the calibration and the step length estimation are performed in an exclusive manner.

However, as described above, the calculation of the average acceleration (A1 to AN) is also performed in estimation of the step length, and the number of steps N is also acquired together with the step detection. That is, the value NA can be calculated according to Expression (11) above even though an exercise is not aimed for calibration. In a normal exercise, since the moving distance D of the exercise is not acquired, it is not possible to calculate the reference step length using Expression (10) above. Thus, even though the value NA can be calculated, the calculated value NA does not have a significant meaning. This is because the reference step length and the reference average acceleration are to be acquired in correlation based on an exercise in the same period. However, to put it the other way, if only the information D can be acquired, calibration may be performed during exercise that aims for the step length estimation. That is, even if it is not aimed for calibration, the value NA may be calculated every exercise and may be used as reference average acceleration candidates. Moreover, when the reference information acquisition instruction is received and the reference distance information D is input, the reference step length may be calculated based on the values D and N, and the reference average acceleration candidates may be used as the reference average acceleration. By doing so, both step length estimation and calibration can be performed during one exercise.

In the present embodiment, a processing period during exercise that mainly aims for calibration is used as the reference information acquisition period, and the highly accurate moving distance acquired in the reference information acquisition period is used as the input distance information. On the other hand, a processing period during exercise that mainly aims for step length estimation is used as the signal value acquisition period, and the highly accurate moving distance acquired in the signal value acquisition period is used as the reference distance information. That is, although different terms are used depending on the purpose of exercise, there is no significant difference in the physical meanings between the reference information acquisition period and the signal value acquisition period, and between the input distance information and the reference distance information.

Moreover, the state detecting device 100 may include the filtering unit 120 that performs a band-pass filtering process on the acceleration detection value and the control unit 130 that changes the filter characteristics of the band-pass filtering process. Moreover, the step detecting unit 140 detects the step cycle based on the acceleration detection value after the band-pass filtering process. The control unit 130 changes the filter characteristics of the band-pass filtering process based on the step cycle detected by the step detecting unit 140.

In this way, it is possible to perform an appropriate filtering process on the acceleration detection value acquired by the acquiring unit 110. Further, the filter characteristics may be adaptively changed based on the step cycle. As shown in FIG. 1, the acceleration detection value includes peaks at frequencies other than the frequency corresponding to the step frequency, and these components are a hindrance to the processing. Thus, by performing a filtering process of passing components of the step frequency and blocking peaks of the other frequencies, it is possible to facilitate the subsequent processing. However, since the step frequency changes according to the exercise state (specifically, the pace of the walking or running of the user), the filter characteristics may be changed according to a change in the exercise state. Whether a component of a certain frequency is passed or blocked by the filter may be determined by a cut-off frequency. In the case of a band-pass filter, a passband may be set based on the upper-limit value and the lower-limit value of the cut-off frequency in such a way that components of frequencies included in the passband are passed and components of the other frequencies are blocked.

Moreover, as shown in FIG. 5, the state detecting device 100 may include the distance information calculating unit 170 that calculates the distance of running or walking based on the step length estimated by the step length estimating unit 160.

In this way, it is possible to calculate the moving distance of the user based on the estimated step length. For example, if the step length is estimated every step, a cumulative sum of the step length may be calculated. Moreover, if the step length per step is estimated every M (M is an integer of 2 or more) steps due to a reason that the average acceleration is calculated every M steps, the moving distance can be calculated by taking the product between the calculated step length and M.

Moreover, the state detecting device 100 may include the determining unit 150 that determines whether an exercise state of the user is a running state or a walking state based on the acceleration detection value. Moreover, when the exercise state is determined to be the running state, the distance information calculating unit 170 calculates the distance information based on the step length estimated by the step length estimating unit 160. Moreover, when the exercise state is determined to be the walking state, the distance information calculating unit 170 calculates the distance information based on a predetermined step length.

Here, the determination result in the determining unit 150 is not limited to the running state and the walking state, the determination result may be a third state that is not the running state or the walking state.

In this way, the step length used in calculation of the distance information may be changed between the running state and the walking state. Since the exercise in the running state is more dynamic than that of the walking state, the step length is considered to change dynamically. Thus, in order to deal with such a change, the estimation result of the step length estimating unit 160 may be used as the step length. In contrast, since the exercise in the walking state is relatively slow, the change in the step length is small. Thus, it is considered that a problem may rarely occur even when the distance information is calculated using the predetermined step length. By doing so, since it is not necessary to perform the step length estimation process when the exercise state is determined to the walking state, it is possible to decrease a processing load.

Moreover, the present embodiment described above may be applied to an electronic apparatus that includes the state detecting device 100 described above.

In this way, it is possible to realize the electronic apparatus including the state detecting device 100 shown in FIG. 4. As a typical example of the electronic apparatus, the above-described wristwatch-type device can be considered. As shown in FIG. 4, the wristwatch-type device may include the display unit 40 or the like in addition to the state detecting device 100 and the acceleration sensor 10. In FIG. 4, although the communication unit 30 is provided for communication with an external host computer, if communication is not performed (or performed less frequently), all processes can be basically performed within the wristwatch-type device.

Moreover, the present embodiment described above may be applied to a program that causes a computer to function as: the acquiring unit 110 that acquires the acceleration detection value from the acceleration sensor 10, the average acceleration calculating unit 162 that calculates the average acceleration in each predetermined period based on the acceleration detection value, the reference information acquiring unit 164 that acquires the reference average acceleration as well as the reference step length, and the step length estimating unit 160 that estimates the step length. In this case, the step length estimating unit 160 estimates the step length based on the ratio of the average acceleration to the reference average acceleration as well as the reference step length.

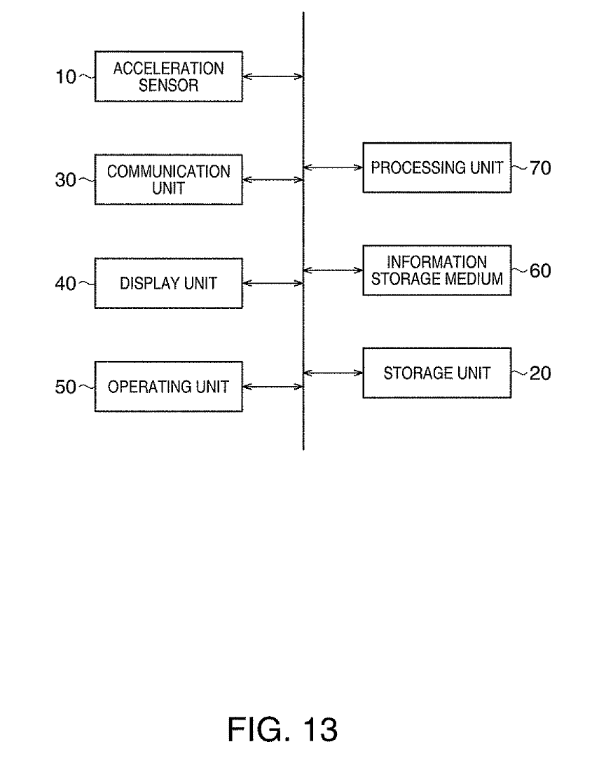

In this way, the same processes as the state detecting device 100 described above can be realized by the program. Moreover, the program is recorded on an information storage medium. Here, as the information storage medium, various recording media that can be read by a system, such as an optical disc such as DVD or CD, an opto-magnetic disk, a hard disk (HDD), or memory such as nonvolatile memory or RAM may be considered. For example, in a system (an electronic apparatus or the like that includes a processing unit 70 that is realized by a CPU, a GPU, or the like) of FIG. 13, the program is stored in an information storage medium 60 and read by the processing unit 70, and the processes are performed. Moreover, when a system (for example, a PC) separated from the acceleration sensor 10 that is attached to the user is considered as a configuration in which the acceleration sensor 10 is removed from FIG. 13, the program may be stored in the information storage medium 60 included in the system. In the case of a PC or the like, since generally it is not considered that the PC is attached to the user, the sensor information is acquired via wireless communication or the like from the acceleration sensor 10 configured as a separate unit, and the processing unit 70 (CPU or the like) performs processes on the sensor information based on the program stored in the information storage medium 60.

Moreover, the present embodiment described above may be applied to the state detecting device 100 that includes the acquiring unit 110 that acquires the acceleration detection value from the acceleration sensor 10, the average speed calculating unit that calculates the average speed in each predetermined period based on the acceleration detection value, the reference information acquiring unit 164 that acquires the reference average speed as well as the reference step length, and the step length estimating unit 160 that estimates the step length. The step length estimating unit 160 estimates the step length based on the ratio of the average speed to the reference average speed as well as the reference step length.

Moreover, the present embodiment described above may be applied to a program for causing a computer to function as the acquiring unit 110 that acquires the acceleration detection value from the acceleration sensor 10, the average speed calculating unit that calculates the average speed in each predetermined period based on the acceleration detection value, the reference information acquiring unit 164 that acquires the reference average speed as well as the reference step length, and the step length estimating unit 160 that estimates the step length. The step length estimating unit 160 estimates the step length based on the ratio of the average speed to the reference average speed as well as the reference step length.

In this way, it is possible to perform processing based on the average speed rather than the average acceleration. Specifically, the processing corresponds to Expressions (13) to (16) above. The contents of the other processing are the same as those of the processing that uses the average acceleration, and detailed description thereof will not be provided. When the present embodiment is applied to a program, the program is similarly stored in the information storage medium 60 shown in FIG. 13.

The embodiments have now been described in detail. However, it may be easily understood by those skilled in the art that a number of modifications are possible insofar as they do not deviate from the new matters and effects of the invention. Accordingly, all such modifications are to be included in the scope of the invention. For example, in the specification or the drawings, a term described at least once with a different term having the same or a broader meaning may be replaced with that different term described anywhere in the specification or the drawings. Moreover, the configuration and operation of the state detecting device are not limited to those described in the present embodiments, and various modifications are possible.

What is claimed is:

1. A state detecting device comprising:
an acquiring unit that acquires an acceleration detection value from an acceleration sensor;
an average acceleration calculating unit that calculates an average acceleration in each predetermined period based on the acceleration detection value;
a reference information acquiring unit that acquires a reference average acceleration and a reference step length; and
a step length estimating unit that estimates a step length based on a ratio of the average acceleration to the reference average acceleration as well as the reference step length.

2. The state detecting device according to claim 1, further comprising:
a step detecting unit,
wherein the reference information acquiring unit acquires the reference step length based on input distance information and the number of steps detected by the step detecting unit in a reference information acquisition period.

3. The state detecting device according to claim 2,
wherein the reference information acquiring unit acquires the reference average acceleration based on the average acceleration acquired in the reference information acquisition period and the number of steps.

4. The state detecting device according to claim 2,
wherein when the reference average acceleration is NA, the reference step length is NS, a coefficient is C, and the average acceleration acquired at a predetermined point in time is An, the step length estimating unit calculates the step length Sn corresponding to a point in time when the average acceleration An is acquired according to an expression Sn−C×(An/NA)×NS.

5. The state detecting device according to claim 2,
wherein the input distance information is information input by a user or external data.

6. The state detecting device according to claim 2,
wherein the reference information acquiring unit calculates reference average acceleration candidates based on the average acceleration in a signal value acquisition period and the number of steps detected in the signal value acquisition period, and
when a reference information acquisition instruction is received, the reference information acquiring unit acquires the reference average acceleration candidate correlated with the reference step length in the signal value acquisition period as the reference average acceleration.

7. The state detecting device according to claim 6,
wherein when the reference information acquisition instruction is received, the reference information acquiring unit acquires the reference distance information of the running or the walking in the signal value acquisition period.

8. The state detecting device according to claim 7,
wherein the reference distance information is information input by a user or external data.

9. The state detecting device according to claim 2,
wherein the average acceleration calculating unit calculates the average acceleration in each of the predetermined periods set based on a point in time when steps are detected by the step detecting unit.

10. The state detecting device according to claim 9, further comprising:
a filtering unit that performs a band-pass filtering process on the acceleration detection value; and
a control unit that changes filter characteristics of the band-pass filtering process of the filtering unit,
wherein the step detecting unit detects step cycle information based on the acceleration detection value after the band-pass filtering process, and
the control unit adaptively changes the filter characteristics of the band-pass filtering process based on the step cycle information detected by the step detecting unit.

11. The state detecting device according to claim 1, further comprising:
a distance information calculating unit that calculates distance information of running or walking based on the step length estimated by the step length estimating unit.

12. The state detecting device according to claim 11, further comprising:
a determining unit that determines whether the acceleration detection value indicates a running state or a walking state,
wherein when the determining unit determines that the acceleration detection value indicates the running state, the distance information calculating unit calculates the distance information based on the step length estimated by the step length estimating unit, and when the determining unit determines that the acceleration detection value indicates the walking state, the distance information calculating unit calculates the distance information based on a predetermined step length.

13. A state detecting device comprising:
an acquiring unit that acquires an acceleration detection value from an acceleration sensor;
an average speed calculating unit that calculates an average speed in each predetermined period based on the acceleration detection value;
a reference information acquiring unit that acquires a reference average speed and a reference step length; and
a step length estimating unit that estimates a step length based on a ratio of the average speed to the reference average speed as well as the reference step length.

14. An electronic apparatus comprising the state detecting device according to claim 1.

15. An electronic apparatus comprising the state detecting device according to claim 2.

16. An electronic apparatus comprising the state detecting device according to claim 3.

17. An electronic apparatus comprising the state detecting device according to claim 4.

18. An electronic apparatus comprising the state detecting device according to claim 5.

19. A program for causing a computer to function as:
an acquiring unit that acquires an acceleration detection value from an acceleration sensor;
an average acceleration calculating unit that calculates an average acceleration in each predetermined period based on the acceleration detection value;
a reference information acquiring unit that acquires a reference average acceleration and a reference step length; and
a step length estimating unit that estimates a step length based on a ratio of the average acceleration to the reference average acceleration as well as the reference step length.

20. A program for causing a computer to function as:
an acquiring unit that acquires an acceleration detection value from an acceleration sensor;
an average speed calculating unit that calculates an average speed in each predetermined period based on the acceleration detection value;
a reference information acquiring unit that acquires a reference average speed and a reference step length; and
a step length estimating unit that estimates a step length based on a ratio of the average speed to the reference average speed as well as the reference step length.
